(19) United States
(12) Patent Application Publication
(10) Pub. No.: US 2011/0060633 A1
(43) Pub. Date: Mar. 10, 2011

(54) METHOD AND APPARATUS FOR RAPIDLY SOURCING RESUMES FOR AN EMPLOYMENT WEBSITE

(75) Inventor: Murugavel Janakiraman, Chennai (IN)

(73) Assignee: CONSIM INFO PVT LTD., Chennai (IN)

(21) Appl. No.: 12/991,762

(22) PCT Filed: Feb. 17, 2009
(86) PCT No.: PCT/IN09/00110

§ 371 Date: Nov. 9, 2010

(30) Foreign Application Priority Data
May 12, 2008 (IN) 1156/CHE/2008

(51) Int. Cl. G06Q 30/00

(52) U.S. Cl. 705/14.16; 705/14.39

(57) ABSTRACT

The invention discloses an on line incentive-based method for implementing a process innovation, to rapidly source resumes from job-seekers in a cost-effective manner for an employment website and in particular, to reach out to job seekers easily for allowing them to upload their resumes and maintain them online.

### FIELD OF THE INVENTION

The present invention in general, relates to a method and apparatus for implementing a process innovation, to rapidly source resumes from job-seekers in a cost-effective manner for an employment website and in particular, to reach out to job seekers easily for allowing them to upload their resumes and maintain them online. The present invention, also allows employers listed on employment websites to reach the job seekers in a transparent manner.

### BACKGROUND OF THE INVENTION

It is known to persons skilled in the art that a website (alternatively, web site or Web site) is a collection of web pages, images, videos or other digital assets that is hosted on one or more web servers, usually accessible via the Internet.

Organized by function a website may be

a personal website

a commercial website

a government website

a non-profit organization website

Turning a website into an income source is a common practice for web-developers and website owners. Employment website is a very common website in vogue these days. Such sites are job boards and career portals operated by:

commercial enterprises;

newspapers;

radio and television stations;

trade and professional magazines and publications;

professional associations and societies;

college, university, and trade/technical school alumni organizations; and

affinity groups.

Most employment websites invest heavily on advertising online to acquire resumes. Such advertising is targeted at job seekers, inviting them to visit the site and upload their resumes. The number of resumes available with the employment site, influences the sites' capability to get employers to sign-up.

To get the job seekers to upload their resumes, usually the employment sites release advertisements online on other media sites, as well as on print media, television, outdoor and other channels. Sometimes job seekers are also given access, to services like “Resume writing” for an extra cost, or for free.

However, in all the aforesaid cases, there is hardly any incentive for the job seekers beyond this, although various models are used by the employment sites to generate sign-up fees.

Usually, employers have to sign-up for a period of time, making a payment, or for free (if there is some kind of promotion activity), to be able to access a set of resumes for a cost. For the job seekers, there is little or no incentive that is offered, other than of course, the primary incentive of getting a job, which, due to obvious reasons no one can be sure of getting, just by posting his or her resume.

So, attempts are on over the years, to fundamentally change the process, by which employee resumes/job seeker resumes are sourced by employment websites, so that, such fundamental changes in the resume sourcing process, can alter the business dynamics of the employment sites and cause new business models to be born. However, significant development to that effect, has not been achieved.

For example, issued U.S. Pat. No. 7,295,991, discloses a process of quickly determining whether a job seeking candidate is qualified for an available position, by accepting the candidate's resume for storage, presenting the candidate with employer created criteria and/or questions, rating the candidate's response and forwarding only the resumes of qualified candidates to the employers.

Issued U.S. Pat. No. 6,370,510 discloses a method and apparatus which enables an employer to advertise available positions on the internet directly receive resumes from prospective candidates and efficiently organize and screen the received resumes.

Issued U.S. Pat. No. 5,884,270 discloses a system for facilitating employment searches using anonymous communications including a plurality of party terminals, plurality of register terminals and central controller. The system establishes communication channels between the employer and the candidates, while maintaining their anonymity.

Hence none of the aforesaid patents disclose any method and apparatus to rapidly source resumes from job-seekers, in a cost-effective manner for an employment website, so that job seekers who are seeking a job actively get some incentive.

Accordingly, there was a long felt need to develop a method and apparatus for implementing a process innovation, to rapidly source resumes from job-seekers, in a cost-effective manner for an employment website, so that job seekers who are seeking a job actively get some incentive and those who were seeking a job, but are not doing so now, do not get any incentive, and in general business dynamics of the employment sites are altered to cause birth of new business models.

The present invention, achieves this long felt need.

All through out the specification, the words “website” and “employment website” are to be interpreted in the broadest sense of the respective terms and any restriction/limitation, if any, referred to in the specification, is solely by way of example and understanding the present invention and not by way of any sort of limitation/restriction.

### OBJECTS OF THE INVENTION

It is a principal object of the present invention, to provide a method and apparatus for implementation of a process innovation, to rapidly source resumes from job-seekers in a cost-effective manner, for an employment website.

It is a further object of the present invention to provide a method and apparatus for implementation of a process innovation, to rapidly source resumes from job-seekers, so that some incentive is also obtained by the job seeker by posting his or her resume on the employment website.

It is a further object of the present invention, to provide a method and apparatus for implementation of a process innovation, to ensure that the primary incentive of getting a job is successfully delivered to the job seeker, if found suitable, in a cost effective manner.

It is yet another object of the present invention to provide a method and apparatus, for fundamentally changing the process, by which employee resumes/job seeker resumes, are sourced by employment websites.

It is yet another object of the present invention to provide a method and apparatus for altering the business dynamics of the employment sites and cause new business models to be born.

It is yet another object of the present invention to provide a method and apparatus for implementation of a process innovation according to which, the employment site charges employers on a pay per use basis.

It is yet another object of the present invention, to provide a method and apparatus for allowing the job seekers to be paid a part of the revenues, that the employers pay the employment site.

It is a further object of the present invention to provide a method and apparatus for allowing the job seekers to refer more than one friends in a chain system through an employment website, whereby the lions' share of the revenue gets accrued to the job seeker while the remaining is delivered to the referred friend(s).

It is a further object of the present invention to provide a method and apparatus for employment websites, which enables delivering revenues to the job-seekers, which are proportionate to the quality/acceptability of the job seeker as revealed by his or her resume.

It is yet another object of the present invention to provide a method and apparatus for employment websites, whereby the fraud job seekers, who upload their resume multiple times for earning more, are located and eliminated.

How the aforesaid objects are achieved and the other aspects of the present invention will be clear from the following description, which is purely for the sake of understanding the invention and not by way of any sort of limitation.

### SUMMARY OF THE INVENTION

Accordingly the present invention provides an on line incentive-based method for matching job-seekers to potential employers in an internet based employment website including:

maintaining a database of job-seekers with means for posting and updating resumes by the registered job-seekers in said database,

maintaining a database of employers interested in accessing and viewing the job-seekers resume that matches the job requirement criteria for vacant posts with the employers,

identifying the logged employer by login ID and searching the database of job-seekers that matches the job requirement criteria,

allowing the logged employer to access the database of first job-seeker matching the posted job requirement criteria for viewing the profile highlight of the matched job-seeker and also permitting the logged employer for (a) viewing the job-seeker's resume; (b) downloading the viewed resume and (c) receiving the job-seeker's contact information, provided the permission for carrying out steps (a), (b) and (c) are allowed in sequential manner and the logged employer is given the option of carrying out all three steps (a), (b) and (c), the first two steps (a) and (b), only the first step (a) or to skip all and look for next matching profile highlight,

repeating the steps for other matching job-seekers, calculating and generating fee payable by the employer accessing the data base according to a pre-determined fee structure,

calculating and generating the revenue to be shared by respective job-seeker according to a scheme of revenue sharing so that each job-seeker whose resume is viewed, downloaded or whose contact information is taken by an employer shares a fraction of the fee payable by the employer as incentive for posting his resume.

In accordance with preferred embodiments of the on line incentive-based method of the present invention:

revenues delivered to the job seeker are proportionate to the quality/acceptability of his or her resume.

the employment site charges the employers only on downloading contact details and/or resume of job seeker(s)

in the event of a referred job-seeker matching the job requirement who was referred to the site by another registered job-seeker, the referred job-seeker shares a part of the incentive earned by him to the registered job-seeker, who referred him to the employment website, as an incentive for such referral.

the fee payable for gathering contact information is higher than fee payable for downloading job-seekers resume and fee payable for downloading job-seekers resume is higher than fees payable for viewing the resume.

the job requirement criteria posted by the logged employer comprises education and professional qualification, minimum period of work experience, place of posting and designation for the post and optionally remuneration package.

a job-seeker is registered inter alia on the basis of a given contacting facility which is electronically representable, such as telephone number and/or email ID and no second job-seeker is allowed to be registered with identical contacting facility to limit multiple registration by the same job-seeker.

the contact information of the registered job-seeker and his or her resume are maintained in a separate but linked database, so that the contact information can not be accessed by viewing or downloading the job-seeker's resume by the employer(s).

The present invention also provides an apparatus for implementing the on line incentive-based method for matching job-seekers to potential employers as described herein above.

### BRIEF DESCRIPTION OF THE ACCOMPANYING DRAWINGS

The nature and scope of the present invention will be better understood from the accompanying drawings, which are by way of illustration of some preferred embodiments and not by way of any sort of limitation. In the accompanying drawings:

FIG. 1 represents a schematic representation of the conventional operations involved in functioning of employment websites.

FIG. 2 represents a schematic representation of the method and apparatus for implementing the process innovations, in accordance with the present invention.

FIG. 3 represents a flow diagram schematically illustrating how the on line incentive-based method for matching job-seekers to potential employers, operates.

### DETAILED DESCRIPTION OF THE INVENTION

The following describes some preferred embodiments of the present invention, which are purely for the sake of understanding the performance of the invention, and not by way of any sort of limitation.

As stated aforesaid, in the conventional methods of operation of employment websites there is hardly any incentive for the job seekers, although various models are used by the employment sites to generate sign-up fees. The present invention aims at solving this problem by providing a method and apparatus for implementing a process innovation, to rapidly source resumes from job-seekers in a cost-effective manner for an employment website, so that some incentive is also obtained by the job seeker, by posting his or her resume on the employment website.

The present invention fundamentally changes the process by which employee resumes/job seeker resumes are sourced by employment websites. This kind of fundamental change in the resume sourcing process alters the business dynamics of the employment sites and cause new business models to be born.

By changing the job seeker resume sourcing process, a competitively unique advantage is obtained.

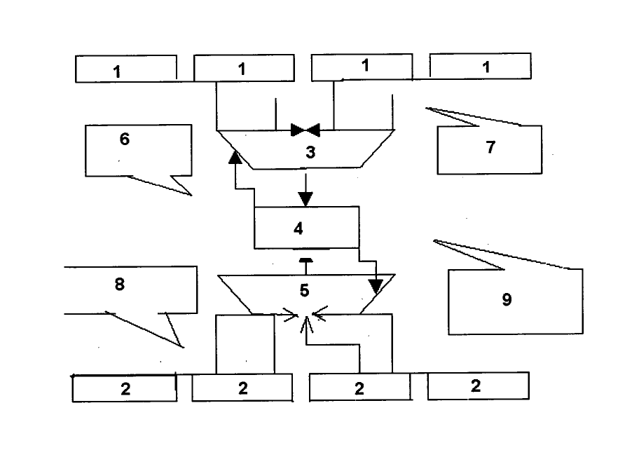

As stated before, FIG. 1, represents a schematic representation of the conventional operations involved in functioning of employment websites. The various reference numerals used in the accompanying FIG. 1, represent the following:

1—Job Seeker

2—Employer

3—Advertisement

4—Employment site

5—Field Sales/Branches

6—Employment sites spend money on advertising to attract resumes from job seekers.

7—Job seekers see the advertisements and if they are seeking a change upload the resume.

8—Employers sign up when they see enough resumes, usually assisted by a sales person.

9—Employment sites have a branch/sales network to convince employers to sign up.

As it will be dear from the accompanying FIG. 1 which is self-explanatory, the known operations of employment sites involves two core processes namely,

a. Sourcing resumes through advertising, word of mouth, media, so on.

b. Signing up employers who are recruiting.

The most common business process employed in doing both of these activities is to do advertising and field sales networks and branch offices.

As the employers are limited in number, and the ticket cost per sign-up is higher, and the employers need reassurance on quality and quantity of profiles they can get access to, face to face meetings are usually essential, to the process of signing up employers.

This is best done by a centralized or distributed sales team working out of one/multiple locations, including remote branches and franchisee outlets. Since the number of job seekers are usually quite high and it is not affordable and feasible in most cases, to reach each job seeker to upload a resume, the process is usually supported by advertising and media spends. Therefore, the employment websites spend large amount of money for acquiring resumes.

Advertising in most of these cases is targeted at the job seeker and aims to reach the job seeker in the media context that is most appropriate for that Job Seeker. For example, a computer website might be used to source resumes of IT professionals, while a business publication might be used to source resumes of senior management.

When both these processes work smoothly, then employers sign-up through the sales channels and job seekers sign up online.

The process innovation, in accordance with the present invention, changes the model fundamentally.

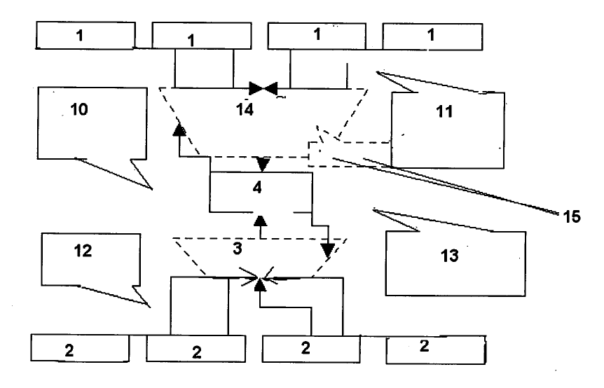

This has been manifested in the accompanying FIG. 2, which is self-explanatory. The various reference numerals used in the accompanying FIG. 2, represent the following:

1—Job Seeker

2—Employer

3—Advertisement

4—Employment Site

10—Revenue share every time their resume is viewed drives word of mouth

11—Job seekers upload their resumes to make money every time their resume is viewed or downloaded by prospective employers, or when they get a call.

12—Employers sign up on line for no fixed cost, on a pay per resume basis.

13—Reach out to large number of employers through media with the promise of no fixed cost.

14—Revenue share for resume download or interview call.

15—Innovation

As it should be clear from the accompanying FIG. 2, in accordance with the present invention, the employment site charges employers on a pay per use basis. This is implemented in two ways:

Employer pays the employment site every time they access the contact details of the job seeker.

Employer pays the employment site every time they view a resume and download it.

In either of the aforesaid cases, the employment site foregoes the sign-up fee and gets revenues only when the employer actually derives value. This is determined by two possible ways. When the Employer sees a highlight of the resume, and decides that the resume is of value, and downloads it, they pay the Employment Site. Alternatively, when the Employer downloads the resume of a Job Seeker without the contact details and when they access the contact details, they pay for the same.

So, the need for the Employer to commit payment to the Employment site is not required, unless and until contact details and/or resume are downloaded. This reduces inhibition on the part of the Employer and allows more sign-ups. More significantly, it allows Small and Medium Enterprises, which as of now, are not part of the ecosystem, to significantly lower their cost of recruitment and derive value from Employment Sites.

The present invention is not just the pay-per-use model for accessing resumes. The more radical invention lies in the change in process for acquiring resumes.

The present invention provides that the Job Seekers are allowed to be paid a part of the revenues, that the Employers pay the Employment site.

This has a number of advantages for Job Seekers:

Job Seekers who are NOT actively seeking jobs are also incentivized to put their resumes online

Job Seekers ensure that they put in accurate details in their resumes (a huge benefit to the Employment sites, which have to invest significantly to get the resumes and confirm accuracy of information)

Job Seekers are free to upload resumes without fear of repercussion from their current Employers, since they are ostensibly uploading the resumes for the purpose of revenue generation through prospective Employer access, rather than active job seeking

Job Seekers also keep their resumes current, to continually keep their “resume value” high.

Employers get a range of advantages too:

a) Employers find it easy to sign-up given the low access costs.

b) Employers pay the Employment site on per resume basis—a fully variable expense.

c) Employers are no longer challenged to source resumes, they are instead challenged to convert the resumes into good job offers, leading to better perks for the Job Seekers too.

As a result, the process innovation (get Employers to pay on a pay-per-use basis and share a part of the revenue with the Job Seekers), creates a whole new business model.

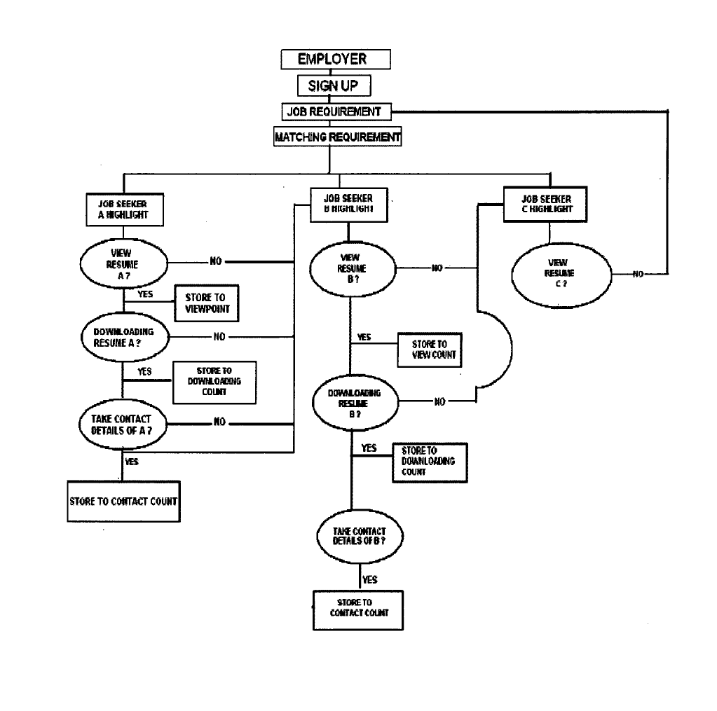

The accompanying self-explanatory FIG. 3 schematically illustrates a preferred embodiment of the on line incentive-based method for matching job-seekers to potential employers, in an internet based employment website, in accordance with the invention. According to the present invention when an employer signs up and hunts for job-seekers, he looks for his requirements, by viewing the highlights of the job-seekers available. The highlight of a job-seeker comprises a brief introduction of his or her, the relevant field, years of experience and so on and not the whole resume including the contact details. Say for instance he locates and matches highlights of three prospective job-seekers A, B and C. Here, it is again clarified that only three prospective jobseekers are shown by way of example and there can be n number of jobseekers involved in the matching process, as it would be clear to persons skilled in the art. Now, say on going through the highlights he finds only job-seekers A and B suitable for viewing the resume. Hence he skips from the highlight of C and checks and downloads the resume of A and B. He eventually finds both the resume suitable and so checks and downloads the contact details of each, which are stored in a separate but linked database. According to the present invention, the employer pays, only if the contact details and/or resume are downloaded.

Since Job Seekers are incentivized to upload their resumes and keep it updated and fresh (to improve their employability and attractiveness to prospective Employers), the invention's success depends on word of mouth to generate resumes. As a result, it is essential to incentivize Word of Mouth. In other words, the present invention also offers a portion of the revenue to the original referrer, who has referred his or her friends/colleagues to register on an Employment site. However, only Job Seekers with resumes posted on the Employment site, gets authorized to refer a friend and otherwise not.

This process has never been tried out in the Employment sites category. Hence, the present invention also motivates, Job Seekers to refer their friends and colleagues to register on the Employment Site. For every such registration, the original referrer gets paid a percentage of revenue that the Job Seeker gets. The referrer gets this revenue up to multiple levels of referrals, which can be set by the business user based on a balance, between revenue sharing and need for word of mouth. Needless to say, the Job Seeker gets the lion's share of the revenue. His/her referrer gets a smaller share of revenue. Finally the referrer, who referred the referrer gets an even smaller share of revenue.

As stated before this model of incentivizing Job Seekers to refer a friend has yet another requirement in that, it allows only Job Seekers with resumes posted on the Employment site to be able to refer a friend. In such cases, it is likely that even if a Job Seeker does not have an impressive resume, if he/she can source resumes from people whose resumes are of much better quality, he/she stands a good chance of earning revenues, that is better than the revenue generating capability of his/her own resume. This drives the word of mouth resume generation in a big way.

The present invention also provides a model which involves setting different costs for different types of resumes. Hard to get profiles, such as highly qualified

professionals, scientists, super-specialists, top business managers and similar other profiles that Employers find difficulty in sourcing, are charged a higher rate for view/download/contact. Freshers who are abundantly available and find difficulty in even getting their first job, on the other hand, may not get any kind of revenues at all. This way, a system is developed, by which people who are less-available in the market, are incentivized to upload their resumes, since their revenue per contact/view/download is high enough to justify their spending time on preparing, polishing and uploading their resumes.

Such variability of pay-out is primarily a function of supply-demand situations, and can cut across verticals, positions, hierarchy, education, experience, etc. This model works well for Employers also, since their challenge when it comes to functions and positions like these, lies in identifying the people. By making the resume available, even at a high cost, the Employer is assured of at least reaching a Job Seeker, who may be amenable to a potential interview conversation.

To overcome the potential threat of misusing the system by uploading the same resume multiple times, a verification process is also set up according to the present invention, by which, even as the Job Seeker fills in his/her resume, or even as he/she uploads their resume, the phone number field is automatically identified and the Job Seeker gets an alert on their phone (to validate the legitimacy and existence of their phone number). Multiple options of such alert are available including SMS, IVR, Callback. Preferably, such verification process may be applied by utilizing the contact email ID of the job-seeker to validate the legitimacy and existence of such email ID. Once the system has a validated phone number/email for a particular resume, the system automatically dedupes against the field, every time a new resume is added to the Employment site, and confirms that the phone number/email is unique or has not been used multiple times. The number of times a phone number/email can be used is also dynamically set and it is envisaged that in most cases, not more than two resumes can be uploaded into the system with the same phone number/email.

The aforesaid process of verification has been explained with reference to a phone number and/or email ID but is not limited to these, and any other contacting facility, which is electronically representable may be utilized.

This logic can be extended to any other field in the database and is eventually estimated to be based on a sophisticated dedupe algorithm, which checks multiple fields in real-time and flag potential duplicate or fraud resumes.

The primary achievements of the present invention are as follows apart from the other advantages.

1. Employment web site domain is a crowded category with a large number of players. In such a category, a process or product innovation is needed to stand out and to create a difference. Such a difference is what the present invention aims to create.

2. The present invention (in process) pays Job Seekers a share of the revenue made by an Employment website from an Employer who seeks to reach that Job Seeker.

3. No such system and method hitherto existed to pay Job Seekers, a share of revenue for putting up, and maintaining their resumes. This model changes the dynamics of the Employment websites because, it alters the business equation substantially.

4. Instead of paying money to media for sourcing resumes, the present invention ends up paying the Job Seeker. This delivers value to the person who is eventually responsible for generating revenues to the Employment site.

5. The present invention facilitates reaching out to millions of Job Seekers at a very low cost, as well as signing-up hundreds of thousands of Employers. This technical advancement and economic significance, achieved by the present invention are unique and hitherto unknown.

The present invention has been described with reference to some preferred embodiments and drawings, purely for the sake of understanding the performance of the invention and not by way of any limitation and it includes all legitimate variations within the limit of what has been described herein before and claimed hereinafter.

1. An on line incentive-based method for matching job-seekers to potential employers in an internet based employment website including, maintaining a database of job-seekers with means for posting and updating resumes, maintaining a database of employers interested in accessing and viewing the job-seekers resumes, identifying the logged employer by login ID and searching the database of job-seekers that matches the job requirement criteria, allowing the logged employer to access the database of first job-seeker matching the posted job requirement criteria for viewing the detailed profile provided the permission for carrying out steps (a), (b) and (c) are allowed in sequential manner and the logged employer is given the option of carrying out all three steps (a), (b) and (c), the first two steps (a) and (b), only the first step (a) or to skip all and look for next matching profile highlight,
repeating the steps for other matching job-seekers, calculating and generating fee payable by the employer accessing the data base according to a pre-determined fee structure,
calculating and generating the revenue to be shared by respective job-seeker according to a scheme of revenue sharing so that each job-seeker whose resume is viewed, downloaded or whose contact information is taken by an employer shares a fraction of the fee payable by the employer as incentive for posting his resume.

2. The method as claimed in claim 1 wherein revenues delivered to the job seeker are proportionate to the quality/acceptability of his or her resume.

3. The method as claimed in claim 1 wherein the employment site charges the employers only on downloading contact details and/or resume of job seeker(s).

4. The method as claimed in claim 1, wherein in the event of a referred job-seeker matching the job requirement who was referred to the site by another registered job-seeker, the referred job-seeker shares a part of the incentive earned by him to the registered job-seeker, who referred him to the employment website, as an incentive for such referral.

5. The method as claimed in claim 1, wherein the fee payable for gathering contact information is higher than fee payable for downloading job-seekers resume and fee payable for downloading job-seekers resume is higher than fee payable for viewing the resume.

6. The method as claimed in claim 1, wherein the job requirement criteria posted by the logged employer comprises educational and professional qualification, minimum period of work experience, place of posting and designation for the post and optionally remuneration package.

7. The method as claimed in claim 1, wherein a job-seeker is registered inter alia on the basis of a given contacting facility which is electronically representable, such as telephone number and/or email ID and no second job-seeker is allowed to be registered with identical contacting facility to limit multiple registration by the same job-seeker.

8. The method as claimed in claim 1, wherein the contact information of the registered job-seeker and his or her resume are maintained in a separate but linked database, so that the contact information can not be accessed by viewing or downloading the job-seeker's resume by the employer(s).
